(19) United States
(12) Patent Application Publication
(10) Pub. No.: US 2026/0245921 A1
(43) Pub. Date: Aug. 20, 2026

(54) GASKET INFUSED ELECRODE SUBSTRATE AND METHODS FOR FORMING THE SAME

(71) Applicants: SAUDI ARABIAN OIL COMPANY, Dhahran (SA); KING ABDULLAH UNIVERSITY OF SCIENCE AND TECHNOLOGY, Thuwal (SA)

(72) Inventors: Anas BINTIN, Dhahran (SA); Phil Woong KANG, Thuwal (SA); Cafer YAVUZ, Thuwal (SA); Javeed MAHMOOD, Thuwal (SA); Seokjin KIM, Thuwal (SA); Issam GEREIGE, Dhahran (SA)

(73) Assignees: SAUDI ARABIAN OIL COMPANY, Dhahran (SA); KING ABDULLAH UNIVERSITY OF SCIENCE AND TECHNOLOGY, Thuwal (SA)

(21) Appl. No.: 19/055,389

(22) Filed: Feb. 17, 2025

(51) Int. Cl. H01M 8/0286; H01M 8/0276; H01M 8/1004

(52) U.S. Cl. CPC H01M 8/0286; H01M 8/0276; H01M 8/1004

(57) ABSTRACT

Provided herein is a gasket infused electrode device and a method for forming the same. The device may include a substrate. The substrate may include a first electrode, a membrane disposed on a first surface of the first electrode, and a second electrode disposed on a first surface of the membrane, the second electrode covering all of the first surface of the membrane and extending laterally past the membrane to be flush with the second portion of the first surface of the first electrode. The device may also include a seal, the seal encapsulating a perimeter of the substrate.

### FIELD OF THE DISCLOSURE

The present disclosure relates generally to sustainable energy systems and, more particularly, to fabricating substrates for use as electrodes.

### BACKGROUND OF THE DISCLOSURE

Electrolysis and fuel cell technology plays a pivotal role in sustainable energy systems, serving as critical components in various technologies for water electrolysis, chlor-alkali processes, production of electrochemical fuels, and the like. For example, electrolysis and fuel cell technologies are used to facilitate the storage and release of electrical energy through electrochemical reactions, enabling the efficient use of renewable energy sources like solar and wind. However, the integration of electrolysis and fuel cell technologies into sustainable energy systems introduces a range of challenges that must be meticulously managed. Intricate fabrication processes often involve the incorporation of multiple elements to achieve desired properties. These processes can be both time-consuming and costly, posing significant barriers to large-scale production and commercialization. Additionally, electrode assemblies within electrolysis and fuel cell technologies may exhibit unique degradation mechanisms that are not fully understood, necessitating extensive research to identify and mitigate factors that contribute to performance loss over time. The compatibility of electrode materials of electrolysis and fuel cell technologies within an existing system also presents challenges, as any component incompatibility can lead to inefficiencies or failures.

Although current techniques for electrode device fabrication within electrolysis and fuel cell technologies are based on technological advancements made over many years, current electrode devices may still be ineffective to achieve ideal results. For example, current electrode devices may be over-complex and prone to degradation over time. Accordingly, there is an impetus to improve current electrode devices within electrolysis and fuel cell technologies to overcome current technological challenges by implementing improvements including, for example: increasing the throughput of electrochemical fuels, enhancing the reliability of current electrode devices within electrolysis and fuel cell technologies, increasing the lifespan of current electrode devices, reducing inefficiencies associated with current electrode devices, increasing the throughput of current electrode devices, reducing errors associated with current electrode devices, decreasing the cost of current electrode devices, and the like.

Consequently, there exists a need for further improvements to current electrode devices to overcome the aforementioned technical challenges and other challenges not mentioned.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a device may include a substrate. The substrate may include a first electrode. The substrate may include a membrane disposed on a first surface of the first electrode. The membrane may include a second surface covering a first portion of the first surface of the first electrode. The membrane may include a side surface defining a second portion of the first surface of the electrode. The second portion of the first surface may extend laterally from the side surface of the membrane to an edge of the first electrode. The second portion of the first surface of the first electrode, the side surface of the membrane, and a first portion of a second surface of the second electrode may form a gasket infused region. The substrate may include a second electrode disposed on a first surface of the membrane, the second electrode covering all of the first surface of the membrane and extending laterally past the membrane to be flush with the second portion of the first surface of the first electrode. The device may include a seal, the seal encapsulating a perimeter of the substrate.

In another embodiment, a method for forming a device may include depositing a first electrode. The method may include depositing a membrane on a first surface of the first electrode. The depositing may include forming a second surface to cover a first portion of the first surface of the first electrode. The depositing may include forming a side surface to define a second portion of the first surface of the electrode. The second portion of the first surface may be formed to extend laterally from the side surface of the membrane to an edge of the first electrode. The second portion of the first surface of the first electrode, the side surface of the membrane, and a first portion of a second surface of the second electrode may form a gasket infused region. The method may include depositing a second electrode on a first surface of the membrane, the second electrode formed to cover all of the first surface of the membrane and formed to extend laterally past the membrane to be flush with the second portion of the first surface of the first electrode. The method may include encapsulating, via a seal, a perimeter of at least the first electrode and the second electrode.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1A is an example of a substrate, fabricated for use in a sustainable energy system.

FIG. 1B is an example of a substrate, fabricated for use in a sustainable energy system.

FIG. 1C is an example of a substrate, fabricated for use in a sustainable energy system, according to one or more aspects of the present disclosure.

FIG. 2A is an example of a substrate having a porous region for gasket infusion, according to one or more aspects of the present disclosure.

FIG. 2B is an example of a substrate having an infused gasket and a porous region for gasket infusion, according to one or more aspects of the present disclosure.

FIG. 2C is an example of a substrate having an infused gasket and a non-porous region, according to one or more aspects of the present disclosure.

FIG. 3 is an example of a substrate, fabricated for use in a sustainable energy system, according to one or more aspects of the present disclosure.

FIG. 4A is an example of a substrate, in the process of fabrication for use in a sustainable energy system, according to one or more aspects of the present disclosure.

FIG. 4B is an example of a substrate, in the process of fabrication for use in a sustainable energy system, according to one or more aspects of the present disclosure.

FIG. 5 is a flow diagram illustrating an example method for forming a substrate, according to one or more aspects of the present disclosure.

FIG. 6 is a schematic diagram illustrating an example system for forming a substrate, according to one or more aspects of the present disclosure.

### DETAILED DESCRIPTION

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

The present disclosure relates generally to sustainable energy systems and, more particularly, to fabricating substrates for use as electrodes.

### Example Fabrication of an Electrode Substrate

Fabrication of electrode component technologies includes material selection, electrode fabrication, and integration into an energy system such a fuel cell or electrolysis device. Each step of electrode fabrication, and electrode fabrication in particular, may be controlled to ensure optimal performance, sustainability, and longevity of sustainable energy systems.

For sustainable energy systems, materials for an electrode assembly are chosen based on their electrochemical properties, environmental impact, and availability. Where the energy system is a fuel cell or electrolyzer, platinum-based catalysts may be used for both anodes and cathodes. The choice of material may influence the energy density, power density, and cycle life of the energy system. Electrode fabrication involves preparation of the active and selected material, the formation of the electrode structure, and the application of any necessary coatings or binders. The active material may be mixed with conductive additives and binders to form a slurry, which may then be coated onto a current collector, such as aluminum or copper foil, porous metal (e.g., Ni) foams, meshes, carbon papers, or any other suitable material. This coating process can be performed using techniques such as doctor blade coating, slot-die coating, or spray coating, depending on the desired thickness and uniformity of the electrode layer. These coating processes are described in further detail, below. The coated electrodes may then be dried to remove any solvents and to ensure proper adhesion of the active material to the current collector. In at least one example, additional treatments such as calendaring (e.g., rolling) may be applied to improve an electrode's mechanical properties and electrical conductivity.

The integration of the electrodes into the energy system may involve assembling the individual components into a complete device. In fuel cells and in certain electrolysis devices, the electrodes may be integrated into a membrane electrode assembly (MEA), which may include a proton exchange membrane (PEM) or an alkaline exchange member (AEM), and gas diffusion layers. The MEA is then assembled into a stack, with each cell connected in series to increase the overall voltage and power output. The MEA is an electrochemical device that may assist in conversion of chemical energy into electrical energy through redox reactions. The MEA may include an anode, a cathode, an electrolyte, and optional catalysts. The anode is where the fuel, typically hydrogen, is oxidized, splitting into protons and electrons. These protons migrate through the electrolyte, a selective ion-conducting material such as a PEM, an AEM, or a ceramic in solid oxide fuel cells (SOFCs), to the cathode. The electrons travel through an external circuit, generating an electric current. At the cathode, the protons, electrons, and oxygen from the air combine to form water, completing the electrochemical process. The anode and cathode are often coated with catalysts, such as platinum, to enhance reaction rates. These components are assembled into a compact, layered substrate, with the electrolyte sandwiched between the anode and cathode, and the entire substrate is housed within a casing that provides mechanical support and facilitates the flow of reactants and products. This layered substrate allows for efficient ion transport and electron flow, making fuel cells highly effective for various applications, from portable electronics to automotive power systems.

An MEA is a key component of a PEM. The MEA may include the PEM, a set of catalyst layers, and a set of gas diffusion layers (GDLs).

The PEM, which may be fabricated from a perfluorosulfonic acid (PFSA) polymer (e.g., Nafion), may serve as the electrolyte. This PEM may be responsible for the selective transport of protons (H⁺ ions) from the anode to the cathode while acting as an electronic insulator to prevent the passage of electrons and as a barrier to gas crossover. The PEM's ionic conductivity, mechanical stability, and chemical resistance may influence the fuel cell's performance and durability. The catalyst layers may be positioned on either side of the PEM and may be composed of platinum or platinum-alloy nanoparticles dispersed on a high-surface-area carbon support. These layers may be applied using techniques such as inkjet printing, decal transfer, spray coating, or screen printing to achieve a uniform and thin layer. The catalyst layer at the anode facilitates the oxidation of hydrogen molecules (H₂) into protons and electrons through the reaction: H₂→2H⁺+2e⁻. The protons migrate through the membrane to the cathode, while the electrons travel through an external circuit, generating an electric current. At the cathode, the catalyst layer facilitates the reduction of oxygen molecules (O₂) in the presence of protons and electrons to form water (H₂O) through the reaction: O₂+4H⁺+4e⁻→2H₂O.

In some embodiments, an AEM may be used in place of a PEM. An AEM may be considered a specialized polymer membrane configured or otherwise arranged to facilitate the selective transport of anions, such as hydroxide ions (OH⁻) , while blocking the passage of cations and neutral molecules. AEMs may be characterized by high ion conductivity, chemical stability in alkaline environments, mechanical strength, and ability to retain water for effective hydration. In fuel cells, AEMs may facilitate the movement of hydroxide ions from the cathode to the anode, facilitating the electrochemical reactions necessary for electricity generation. In water electrolysis, they allow the transfer of hydroxide ions between electrodes, promoting the efficient splitting of water into hydrogen and oxygen. Additionally, AEMs may be used in redox flow batteries to separate electrolyte solutions while permitting anion transfer, and in various ion exchange processes for water purification and chemical synthesis. The advantages of AEMs include high efficiency due to low resistance and high ionic conductivity, cost-effectiveness from the use of less expensive materials and non-precious metal catalysts, and environmental benefits from operation at lower temperatures and less corrosive conditions.

An AEM may be used in the formation of an MEA may involves several critical steps to ensure optimal performance and durability of the electrochemical device. The process begins with the preparation of the AEM, which must be properly hydrated to maintain its ionic conductivity. The AEM may then be sandwiched between the anode and the cathode. As with the PEM, the anode and the cathode may be composed of a catalyst layer. Where the AEM is used as a membrane, the anode and the cathode may contain non-precious metal catalysts suitable for alkaline environments. A GDL configured or otherwise arranged to facilitate the transport of reactant gases to the catalyst sites is also included. The catalyst layers may be coated onto the GDLs and then pressed or bonded to the AEM under controlled temperature (e.g., room temperature) and pressure conditions to ensure good adhesion and minimal interfacial resistance. The assembled MEA is then placed within a cell housing, where it is secured and connected to the external circuit and gas supply systems. The integration process described here may also account for the mechanical and chemical stability of the AEM to withstand the operational conditions of the device, including temperature fluctuations, pressure variations, and exposure to alkaline media.

The entire stack is then subjected to a pressing process (e.g., a hot-pressing process for an PEM), where it is compressed (e.g., at elevated temperatures and pressures for a PEM) to ensure good adhesion between the layers and to eliminate any voids. Quality control measures, including electrochemical performance testing and structural integrity assessments, may be conducted to ensure that the MEA meets the industry specifications for fuel cell and/or electrolysis operation.

In at least one embodiment, slot-die coating is a precision coating technique used to apply a uniform layer of material onto a substrate. This method may be used to produce highly uniform and controlled thin films. The slot-die coating process involves the use of a slot-die head, which dispenses the coating material through a narrow slot onto the moving substrate. A slot-die coating system may include a slot-die head, a coating material, a substrate, and a metering system. The slot-die head is typically made from stainless steel or other corrosion-resistant materials and is designed with a precision-machined slot through which the coating material is extruded. The coating material, which can be a solution, suspension, or slurry, may be delivered to the slot-die head via a metering system that controls the flow rate and pressure. The substrate, which can be a continuous web or discrete sheets, is transported beneath the slot-die head at a controlled speed.

In at least one embodiment, doctor blade coating, also known as knife coating, is a precision technique used to apply a uniform layer of material onto a substrate. This method may use a blade, often referred to as a doctor blade, which is positioned at a specific angle and distance from the substrate to control the thickness of the applied coating. A doctor blade coating system may include a substrate, a coating material, a doctor blade, and a coating head. The substrate, which can be a continuous web or discrete sheets, may be fed through the coating head where the coating material is applied. The coating material, which can be in the form of a liquid, slurry, or paste, may be deposited onto the substrate ahead of the doctor blade. The doctor blade, made from materials such as stainless steel, ceramic, or polymer, may be precisely positioned to spread the coating material evenly across the substrate's surface. The thickness of the applied coating may be controlled by the gap between the doctor blade and the substrate, known as the blade gap. This gap can be adjusted to achieve the desired coating thickness, which can range from a few micrometers to several millimeters. The angle of the doctor blade relative to the substrate also plays a crucial role in determining the coating's uniformity and quality. A steeper angle generally results in a thinner and more uniform coating, while a shallower angle can lead to a thicker and less uniform layer.

For any catalyst application system contemplated herein, the thickness and uniformity of the applied coating may be determined by the gap between the head and the substrate, the flow rate of the coating material, and the speed of the substrate. The gap, also known as the coating gap, can be precisely adjusted to achieve the desired coating thickness, which can range from a few nanometers to several micrometers. The flow rate of the coating material may be controlled by the metering system, which can include pumps, valves, and flow sensors to ensure a consistent and accurate delivery of the material. The substrate speed may be synchronized with the flow rate to maintain a uniform coating thickness across the entire substrate.

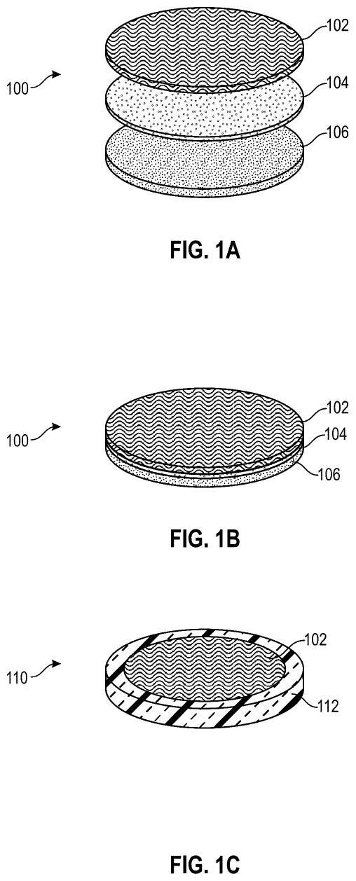

FIGS. 1A and 1B illustrate an example of a substrate 100, fabricated for use in a fuel cell and/or electrolysis device. As shown in FIG. 1A, substrate 100 includes a first electrode 102, a membrane 104, and a second electrode 106. First electrode 102 and second electrode 104 may be considered a cathode and an anode, where first electrode 102 is a cathode and second electrode 106 is an anode, or the electrode 102 is an anode and the second electrode 106 is a cathode. As shown in FIG. 1B, substrate 100may be a stack, where first electrode 102 and second electrode 106 are separated by membrane 104. In at least one embodiment, this may allow ion transportation between electrodes 102/106, but may prevent electrical short circuit. In at least one embodiment, membrane 104 may be considered a diaphragm. In at least one embodiment, electrodes 102/106 may be conductive and porous material (e.g., Ni foam, metal mesh, metal wool, carbon paper, carbon cloth) with or without electrochemically functional material coatings. In at least one embodiment, electrodes 102/106 can each be a single electrode, or can be a group of multiple electrodes configured or otherwise arranged in a stack. In at least one embodiment, membrane 104 can formed of porous or non-porous materials that are configured or otherwise arranged as a separator for electrodes 102/106 while allowing ion transportation in the substrate 100.

In at least one embodiment, first electrode 102, membrane 104, and a second electrode 106 are stacked according to the substrate 100 of FIG. 1B using an external structure. In a set of non-limiting examples, an external structure may include gaskets, O-rings, holding slots, and the like.

### Aspects Related to a Gasket-Infused Electrode Substrate

Embodiments of the present disclosure introduce an enhanced electrode substrate, which incorporates a partially infused gasket to streamline and fortify the substrate 100 and form, for example, substrate 110 of FIG. 1C.

As shown in FIG. 1C, substrate 110 includes first electrode 102 and a seal 112. It also includes membrane 104 and second electrode 106, though not shown in FIG. 1C. In at least one embodiment, the seal 112 is affixed about the periphery of first electrode 102, membrane 104, and second electrode 104. In at least one embodiment, the seal 112 may function as a gasket for substrate 110, maintaining the structure of substrate 110. The seal 112 may be partially infused with the first electrode 102, membrane 104, and second electrode 104, such that the seal 112 provides both encapsulating support about an external surface (not shown) of the substrate 110 and structural support for internal components of the substrate 110. In at least one embodiment, the seal 112 may be a non-conductive elastic binder. By applying seal 112 of FIG. 1C, substrate 110 may be considered a streamlined electrode substrate, arranged or otherwise configured to increase the fidelity of the seal and to mitigate the need for external support structures for a MEA. The seal is to be applied through a casting process at the melting temperature of the sealing material.

The substrate 110 may be considered one embodiment of a gasket-infused electrode assembly (GIEA). A GIEA achieves simplification by enveloping the electrode assembly's perimeter with a non-conductive, elastic material seal, which partially permeates the porous elements, transforming complex assemblies into a single, easily maintained electrolyzer component.

In at least one embodiment, and elastic material seal may be any non-conductive material that can be processed in a liquid state. Suitable materials may include silicon rubber, thermoplastic polyurethane, ionomer sealant, polyvinyl butyral (PVB), and ethylene propylene diene monomer (EPDM).

The GIEA may also improve the function of the current collector from direct contact conduction to facial compression, enhancing the overall efficiency and reliability of the system. In certain embodiments, a GIEA may be formed of materials such as electrically non-conductive, flexible materials (e.g., such as silicones, rubbers, EPDM, Teflon, epoxy, and the like). GIEA gasket material may be fabricated around the periphery of the electrode. This periphery may include a gasket infusion region and a gasket seal region. A gasket infused region may be considered a region where gasket material is infused into the porous structures of the electrode to physically fill the void space within. A diaphragm or membrane in the GIEA may be infused with the gasket material. A gasket seal region is where the gasket creates a seal on the outer periphery of the electrode assembly. The gasket infused seal regions are connected as a single material. Depth of each region can vary.

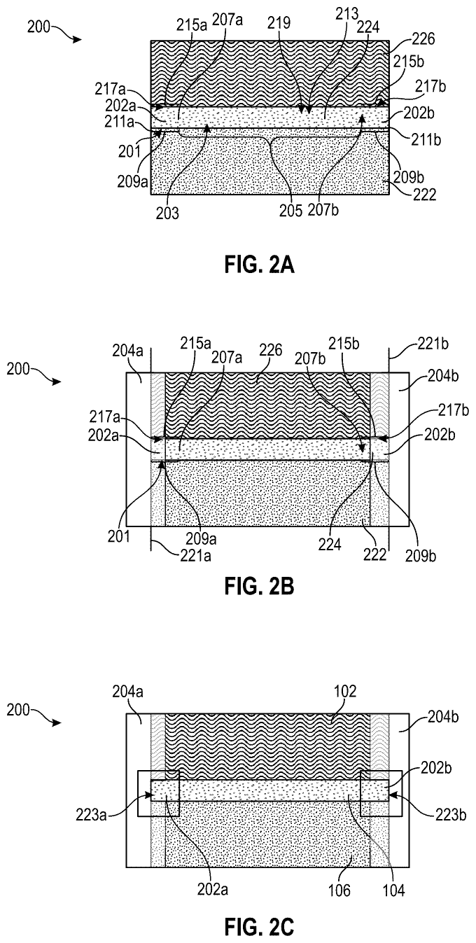

FIGS. 2A-2C illustrate cross-sectional images of a substrate 200 (e.g., a GIEA) at different points in a fabrication process. FIG. 2A illustrates substrate 200 prior to the application of a seal 204. Substrate 200 of FIG. 2A includes first electrode 222, a membrane 224, and a second electrode 226. The substrate 200 may be formed by first depositing first electrode 222, then depositing a membrane on a top (e.g., first, where the substrate is differently oriented) surface 201 of first electrode 222. In at least one embodiment, depositing may include forming a bottom (e.g., second, where the substrate is differently oriented) surface 203 to cover a first portion 205 of top surface 201 of first electrode 222 and forming a side surface 207a-b to define a second portion 209a-b of top surface 201 of first electrode 222. As shown in FIG. 2A, second portion 209a-b of top surface 201 is formed to extend laterally from side surface 207a-b of membrane 224 to an edge 211a-b of first electrode 222. Side surface 207a-b, second portion 209a-b, and edge 211a-b are illustrated as components in FIG. 2A, but may be considered as single, continuous elements of substrate 200.

The substrate 200 may continue to be formed by depositing a second electrode 226 on a top surface 213 of membrane 224, second electrode 226 formed to cover all of top surface 213 of membrane 224 and formed to extend laterally past membrane 224 to be flush with second portion 209a-b of top surface 201 of first electrode 222. In at least one embodiment, second portion 209a-b of top surface 201 of first electrode 222, side surface 207a-b of membrane 224, and a first portion 215a-b of a bottom surface 217a-b of second electrode 226 form a gasket infused region 202a-b. In at least one embodiment, first portion 215a-b of bottom surface 217a-b of second electrode 226 extends laterally from top surface 219 of membrane 224 to be flush with second portion 209a-b of top surface 201 of first electrode 222. Bottom surface 217a-b, first portion 215a-b, and gasket infused region 202a-b are illustrated as components in FIG. 2A, but may be considered as single, continuous elements of substrate 200.

Formation of the substrate 200 may end with encapsulating, via a seal, a perimeter 221a-b of at least first electrode 222 and second electrode 226. FIGS. 2B and 2C illustrate substrate 200 after the application of a seal 204. FIG. 2B illustrates substrate 200 where a seal 204a-b is applied using a porous diaphragm. As shown in FIG. 2B, seal 204a-b is disposed within gasket infused region 202a-b. In at least one embodiment, seal 204a-b is physically coupled to second portion 209a-b of top surface 201 of first electrode 222, side surface 207a-b of membrane 224, and first portion 215a-b of bottom surface 217a-b of second electrode 226. FIG. 2C illustrates substrate 200 where seal 204a-b is applied using a non-porous diaphragm. As shown in FIG. 2C, seal 204a-b is disposed substantially flush with an outer portion 223a-b of gasket infused region 202a-b, seal 204a-b not dis posed within gasket infused region 202a-b.

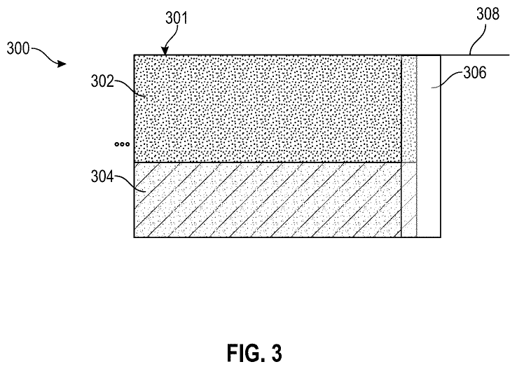

FIG. 3 illustrates an enlarged cross-section at the edge of an example substrate 300 (e.g., a GIEA). Substrate 300 includes an electrode 302, a membrane 304, a seal 306, and may be comparable substrate 200 of FIGS. 2B-2C. In at least one embodiment, the seal 204a-b may be flush with a surface 301 of electrode 302, as illustrated by line 308. By implementing the arrangement of substrate 300, an electrical device may maintain electrical conductivity in a gasket infused region (e.g., gasket infused region 202a-b).

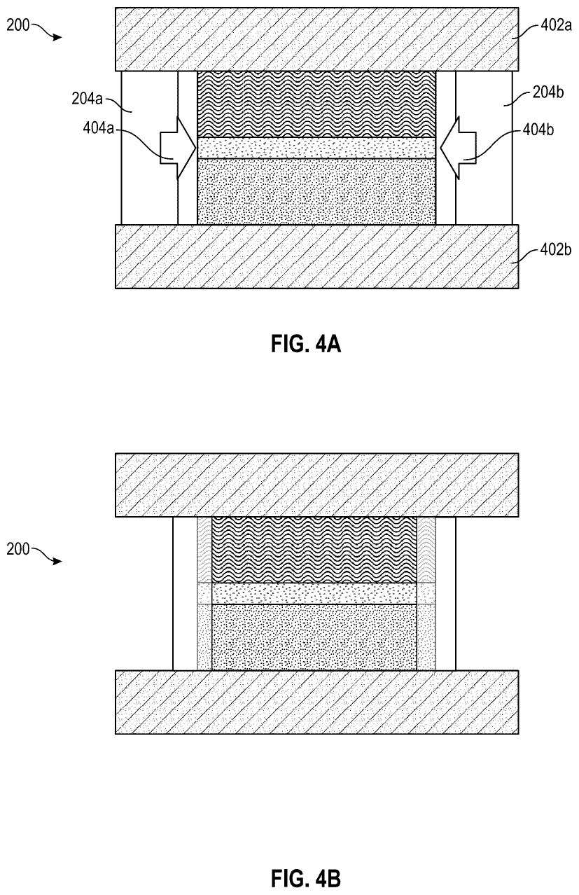

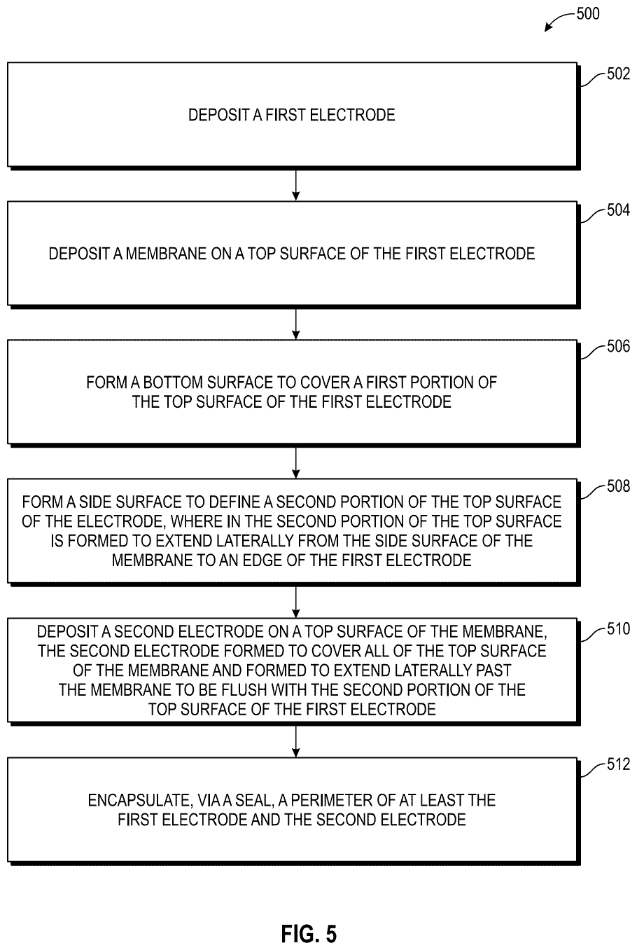

FIGS. 4A-4B illustrate a cross-section of example substrate 200 at different points in the fabrication process (e.g., such as the method 500 of FIG. 5). As shown in FIG. 4A, substrate 200 may be held together by a set of holding plates 402a-b. The seal 204a-b, which at FIG. 4A is fusing gasket material in viscous liquid state, may be two-part curing silicone, two-part curing epoxy, molten thermoplastic, thermosetting plastic, or any other suitable material. The processing temperature can span any range, constrained by the temperature tolerances of the substrate 200 (including the catalyst, which may deactivate above/under certain temperatures), the membrane or diaphragm (as specified by the manufacturer), and the minimum/maximum processing temperatures for the chosen elastic material. The seal 204a-b may be deposited in a direction 404a-b onto the components of substrate 100 to form substrate 200. In at least one embodiment, gasket material can infuse into the substrate 200 through spontaneous capillary action or by external pressure. FIG. 4B illustrates the substrate 200 after curing and/or hardening of the gasket material to form the seal 204a-b. In at least one embodiment, excess gasket materials can be removed.

In at least embodiment, a GIEA represents a unified component that combines electrodes, a membrane/diaphragm, and a sealing mechanism into a cohesive unit within an electrolysis system. This device provides several benefits compared to the current state of the art. For example, GIEA eliminates the need for externally applied gaskets that must have a precise thickness. The GIEA, also does not require an adhesive process, including hot/cold pressing and adhesive curing. Additionally, it permits the stacking of multiple electrode layers and achieves a durable bond of the electrode assembly without the use of extra adhesives or processes. The advantages of GIEA include streamlining the electrolysis device by negating the necessity for various structural elements. It also eliminates the need for a surrounding frame and a support structure for the electrode assembly. Furthermore, GIEA simplifies the electrical connection by allowing direct electrical contact in the gasket-infused region, bypassing the need to separate a current-conducting component and a facial compression component.

Moreover, maintenance may be easier with GIEA, as it is a single-piece component that can be quickly installed or removed from the electrolysis device without the hassle of handling separate sealing elements. GIEA is versatile and can be utilized in any application that demands porous electrodes for electrolysis processes, including water electrolysis, the chlor-alkali process, and the production of electrochemical fuels. In the current state of the art, without gasket integration, there is a risk of seal loss. The GIEA provided herein includes a gasket and partial infusion of gasket materials into the porous electrode structure. This new form of electrode removes the need for gasket optimization and related sealing mechanisms.

### Example Method

FIG. 5 is a schematic flowchart of an example method 500 for forming a substrate, such as substrate 200 of FIGS. 2A-2C.

Method 500 begins at operation 502 by depositing a first electrode.

Method 500 continues to operation 504 with depositing a membrane on a top surface of the first electrode.

Method 500 continues to operation 506 with forming a bottom surface to cover a first portion of the top surface of the first electrode.

Method 500 continues to operation 508 with forming a side surface to define a second portion of the top surface of the electrode, where the second portion of the top surface is formed to extend laterally from the side surface of the membrane to an edge of the first electrode. In at least one embodiment, the second portion of the top surface of the first electrode, the side surface of the membrane, and a first portion of a bottom surface of the second electrode form a gasket infused region. In at least one embodiment, the first portion of the bottom surface of the second electrode extends laterally from the top surface of the membrane to be flush with the second portion of the top surface of the first electrode.

Method 500 continues to operation 510 with depositing a second electrode on a top surface of the membrane, the second electrode formed to cover all of the top surface of the membrane and formed to extend laterally past the membrane to be flush with the second portion of the top surface of the first electrode. In at least one embodiment, the first electrode is an anode and the second electrode is a cathode, or the first electrode is the cathode and the second electrode is the anode.

Method 500 continues to operation 512 with encapsulating, via a seal, a perimeter of at least the first electrode and the second electrode. In at least one embodiment, the seal is disposed within the gasket infused region. In at least one embodiment, the seal is physically coupled to the second portion of the top surface of the first electrode, the side surface of the membrane, and the first portion of the bottom surface of the second electrode. In at least one embodiment, the seal is disposed substantially flush with an outer portion of the gasket infused region, the seal not disposed within the gasket infused region. In at least one embodiment, the seal is a non-conductive elastic material.

In one aspect, method 500, or any aspect related to it, may be performed by a system, device, apparatus, architecture, or system which includes various components operable, configured to, or adapted to perform the method 500.

FIG. 5 is just one example of a method, and other methods including fewer, additional, or alternative operations are contemplated consistent with the disclosure.

In an additional embodiment, an additional example method for forming a substrate includes a first step of aligning and stacking the first electrode, membrane (or diaphragm), and second electrode to ensure that all are centered. In a first optional step, the membrane or diaphragm can be preactivated prior to fabrication. In a second step, the casting process is initiated by uniformly introducing the liquid sealing (e.g., gasket) material around the periphery of the aligned assembly from the first step. In a third step, the sealing material is allowed to solidify. In a fourth step, the finished substrate is removed from a formation apparatus. In a second optional step, unwanted extrusion marks are trimmed.

### Example Devices and Systems

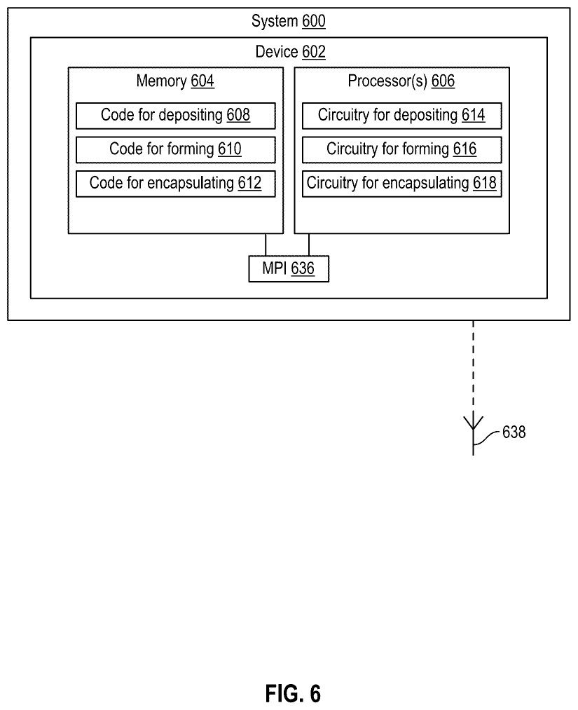

FIG. 6 illustrates a schematic diagram of an example system 600. The system 600 may be implemented as part of a method for forming a substrate as described with respect to FIGS. 1-5. The system 600 may be implemented at a single location or at multiple locations and may be a supervisory system component or may be in communication with a supervisory system component by way of a communication line and/or communication connection. In at least one aspect, the communication line and/or communication connection may be a wireless communication line, a wired communication line, or both, though other types of communication line or connection are contemplated.

The system 600 may include a CPU processing system, which may be configured to form a substrate, as performed by the system 600. The CPU processing system of the system 600 may include one or more processors 606 coupled to a computer readable medium/memory 604 (e.g., via a bus (not shown)). The one or more processors 606 and the computer readable medium/memory 904 may communicate via a message passing interface (MPI) 636. In certain aspects the computer readable medium/memory 604 is configured to store instructions (e.g., computer executable code) that when executed by the one or more processors 606, cause the one or more processors to perform the method 500 described with respect to FIG. 5, or any aspect related to it. Reference to a processor performing a function of system 600 may include one or more processors performing that function of system 600.

In the depicted example, computer-readable medium/memory 604 stores code 608 (e.g., executable instructions) for depositing, code 610 for forming, and code 612 for encapsulating. Processing of code 608-612 may cause the system 600 to perform the method 500 described with respect to FIG. 5, or any aspect related to it.

The one or more processors 606 include circuitry configured to implement (e.g., execute) the code stored in the computer-readable medium/memory 604, including circuitry 614 for depositing, circuitry 616 for forming, and circuitry 618 for encapsulating. Processing with circuitry 614-618 may cause the system 600 to perform the method 500 described with respect to FIG. 5, or any aspect related to it.

Various components of the system 600 may provide means for performing the method 500 described with respect to FIG. 5, or any aspect related to it.

The system 600 may include or be substantially coupled to a communication component 638. In the depicted example, the communication component 638 is an antenna capable of communicating with systems or system components similar to system 600 to perform the method 500 described with respect to FIG. 5, or any aspect related to it. In additional examples, the communication component 638 may be a bus or a wired connection.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

The present disclosure may be a system, a method, and/or a computer program product at any possible technical detail level of integration. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

### Example Aspects

Implementation examples are described in the following numbered aspects:
Aspect 1: A device, including: a substrate, the substrate including: a first electrode; a membrane disposed on a first surface of the first electrode, the membrane including: a second surface covering a first portion of the first surface of the first electrode; and a side surface defining a second portion of the first surface of the electrode, wherein: the second portion of the first surface extends laterally from the side surface of the membrane to an edge of the first electrode; and the second portion of the first surface of the first electrode, the side surface of the membrane, and a first portion of a second surface of the second electrode form a gasket infused region; a second electrode disposed on a first surface of the membrane, the second electrode covering all of the first surface of the membrane and extending laterally past the membrane to be flush with the second portion of the first surface of the first electrode; and a seal, the seal encapsulating a perimeter of the substrate.
Aspect 2: The device of aspect 1, wherein the first portion of the second surface of the second electrode extends laterally from the first surface of the membrane to be flush with the second portion of the first surface of the first electrode.
Aspect 3: The device of any one of aspects 1 through 2, wherein the seal is disposed within the gasket infused region.
Aspect 4: The device of aspect 3, wherein the seal is physically coupled to the second portion of the first surface of the first electrode, the side surface of the membrane, and the first portion of the second surface of the second electrode.
Aspect 5: The device of any one of aspects 1 through 4, wherein the seal is disposed substantially flush with an outer portion of the gasket infused region, the seal not disposed within the gasket infused region.
Aspect 6: The device of any one of aspects 1 through 5, wherein the first electrode is an anode and the second electrode is a cathode, or the first electrode is the cathode and the second electrode is the anode.
Aspect 7: The device of any one of aspects 1 through 6, wherein the seal is a non-conductive elastic material.
Aspect 8: A method for forming a device, including: depositing a first electrode; depositing a membrane on a first surface of the first electrode, wherein the depositing includes: forming a second surface to cover a first portion of the first surface of the first electrode; and forming a side surface to define a second portion of the first surface of the electrode, wherein: the second portion of the first surface is formed to extend laterally from the side surface of the membrane to an edge of the first electrode; and the second portion of the first surface of the first electrode, the side surface of the membrane, and a first portion of a second surface of the second electrode form a gasket infused region; depositing a second electrode on a first surface of the membrane, the second electrode formed to cover all of the first surface of the membrane and formed to extend laterally past the membrane to be flush with the second portion of the first surface of the first electrode; and encapsulating, via a seal, a perimeter of at least the first electrode and the second electrode.
Aspect 9: The method of aspect 8, wherein the second portion of the first surface of the first electrode, the side surface of the membrane, and a first portion of a second surface of the second electrode form a gasket infused region.
Aspect 10: The device of aspect 9, wherein the first portion of the second surface of the second electrode extends laterally from the first surface of the membrane to be flush with the second portion of the first surface of the first electrode.
Aspect: 11 The device of any one of aspects 9 through 10, wherein the seal is disposed within the gasket infused region.
Aspect 12: The device of aspect 11, wherein the seal is physically coupled to the second portion of the first surface of the first electrode, the side surface of the membrane, and the first portion of the second surface of the second electrode.
Aspect 13: The device of any one of aspects 9 through 12, wherein the seal is disposed substantially flush with an outer portion of the gasket infused region, the seal not disposed within the gasket infused region.
Aspect 14: The device of any one of aspects 9 through 13, wherein the first electrode is an anode and the second electrode is a cathode, or the first electrode is the cathode and the second electrode is the anode.
Aspect 15: The device of any one of aspects 9 through 14, wherein the seal is a non-conductive elastic material.
Aspect 16: An apparatus or device including a memory comprising executable instructions, and a processor configured to execute the executable instructions and cause the apparatus to perform a method in accordance with any one of aspects 1-15.
Aspect 16: An apparatus or device, including means for performing a method in accordance with any one of aspects 1-15.
Aspect 17: A non-transitory computer-readable medium including executable instructions that, when executed by a processor of an apparatus, cause the apparatus to perform a method in accordance with any one of aspects 1-15.
Aspect 18: A computer program product embodied on a computer-readable storage medium comprising code for performing a method in accordance with any one of aspects 1-15.

### Additional Considerations

The term “substrate” may refer to the foundational material or base layer upon which an electrode's active materials are deposited or fabricated. A substrate may serve as the support structure for an electrode and contribute to the overall performance and functionality of an electrochemical device (e.g., batteries, fuel cells, or supercapacitors, and the like). A substrate may be constructed from materials that provide electrical conductivity, mechanical stability, and chemical compatibility with the active materials and an electrolyte. Common substrate materials may include metals (e.g., copper, aluminum, or stainless steel), carbon-based materials (e.g., carbon paper, carbon cloth, or graphite), and/or conductive polymers. The choice of substrate material may depend on the specific application and the desired properties of the final electrode. A substrate's surface may be treated or modified to enhance adhesion, conductivity, and the overall performance of the electrode. This can include surface roughening, coating with conductive layers, or applying adhesion promoters. The substrate's thickness, porosity, and flexibility may also influence the electrode's performance, including its electrical conductivity, mechanical strength, and ability to accommodate volume changes during electrochemical reactions. As used herein, the term “substrate” may be considered a “base material,” a “support” member, a “carrier,” a “backing,” a “foundation,” a “platform,” a “matrix,” a “film,” a “sheet,” a “layer,” and a “ground.”

The terminology used herein is for the purpose of describing particular embodiments only and is not intended to be limiting of the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for carrying out this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The disclosure claimed is:

1. A device, comprising:
a substrate, the substrate comprising:
a first electrode;
a membrane disposed on a first surface of the first electrode, the membrane including:
a second surface covering a first portion of the first surface of the first electrode; and
a side surface defining a second portion of the first surface of the electrode, wherein:
the second portion of the first surface extends laterally from the side surface of the membrane to an edge of the first electrode; and
the second portion of the first surface of the first electrode, the side surface of the membrane, and a first portion of a second surface of the second electrode form a gasket infused region;
a second electrode disposed on a first surface of the membrane, the second electrode covering all of the first surface of the membrane and extending laterally past the membrane to be flush with the second portion of the first surface of the first electrode; and
a seal, the seal encapsulating a perimeter of the substrate.

2. The device of claim 1, wherein the first portion of the second surface of the second electrode extends laterally from the first surface of the membrane to be flush with the second portion of the first surface of the first electrode.

3. The device of claim 1, wherein the seal is disposed within the gasket infused region.

4. The device of claim 3, wherein the seal is physically coupled to the second portion of the first surface of the first electrode, the side surface of the membrane, and the first portion of the second surface of the second electrode.

5. The device of claim 1, wherein the seal is disposed substantially flush with an outer portion of the gasket infused region, the seal not disposed within the gasket infused region.

6. The device of claim 1, wherein the first electrode is an anode and the second electrode is a cathode, or the first electrode is the cathode and the second electrode is the anode.

7. The device of claim 1, wherein the seal is a non-conductive elastic material.

8. A method for forming a device, comprising:
depositing a first electrode;
depositing a membrane on a first surface of the first electrode, wherein the depositing includes:
forming a second surface to cover a first portion of the first surface of the first electrode; and
forming a side surface to define a second portion of the first surface of the electrode, wherein:
the second portion of the first surface is formed to extend laterally from the side surface of the membrane to an edge of the first electrode; and
the second portion of the first surface of the first electrode, the side surface of the membrane, and a first portion of a second surface of the second electrode form a gasket infused region;
depositing a second electrode on a first surface of the membrane, the second electrode formed to cover all of the first surface of the membrane and formed to extend laterally past the membrane to be flush with the second portion of the first surface of the first electrode; and
encapsulating, via a seal, a perimeter of at least the first electrode and the second electrode.

9. The method of claim 8, wherein the second portion of the first surface of the first electrode, the side surface of the membrane, and a first portion of a second surface of the second electrode form a gasket infused region.

10. The device of claim 9, wherein the first portion of the second surface of the second electrode extends laterally from the first surface of the membrane to be flush with the second portion of the first surface of the first electrode.

11. The device of claim 9, wherein the seal is disposed within the gasket infused region.

12. The device of claim 11, wherein the seal is physically coupled to the second portion of the first surface of the first electrode, the side surface of the membrane, and the first portion of the second surface of the second electrode.

13. The device of claim 9, wherein the seal is disposed substantially flush with an outer portion of the gasket infused region, the seal not disposed within the gasket infused region.

14. The device of claim 9, wherein the first electrode is an anode and the second electrode is a cathode, or the first electrode is the cathode and the second electrode is the anode.

15. The device of claim 9, wherein the seal is a non-conductive elastic material.
